(19) United States
(12) Patent Application Publication
(10) Pub. No.: US 2026/0140405 A1
(43) Pub. Date: May 21, 2026

(54) ELECTRO-OPTIC PHASE SHIFTERS INCLUDING A SLOTTED WAVEGUIDE STRUCTURE

(71) Applicant: GlobalFoundries U.S. Inc., Malta, NY (US)

(72) Inventor: Aneesh Dash, Bangalore (IN)

(21) Appl. No.: 18/954,962

(22) Filed: Nov. 21, 2024

(51) Int. Cl. G02F 1/035; G02F 1/025

(52) U.S. Cl. CPC G02F 1/035; G02F 1/025; G02F 2202/20

(57) ABSTRACT

Structures for a phase shifter and methods of forming such structures. The structure comprises a first waveguide core, a second waveguide core laterally adjacent to the first waveguide core, and a third waveguide core laterally adjacent to the second waveguide core. The second waveguide core and the first waveguide core are separated by a first slot, and the third waveguide core and the second waveguide core are separated by a second slot. The structure further comprises a layer that overlaps with respective portions of the first waveguide core, the second waveguide core, and the third waveguide core. The layer comprises a first electro-optic material.

### BACKGROUND

This disclosure relates to photonic chips and, more specifically, to structures for a phase shifter and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

A phase shifter is a photonic component that can be used in a photonic integrated circuit to modulate the phase of light propagating in a waveguide core. Phase shifters operating by an electro-optical mechanism have the functionality to control the phase of the light through a change in the effective refractive index of the waveguide core.

Improved structures for a phase shifter and methods of forming such structures are needed.

### SUMMARY

In an embodiment of the invention, a structure for a phase shifter is provided. The structure comprises a first waveguide core, a second waveguide core laterally adjacent to the first waveguide core, and a third waveguide core laterally adjacent to the second waveguide core. The second waveguide core and the first waveguide core are separated by a first slot, and the third waveguide core and the first waveguide core are separated by a second slot. The structure further comprises a layer that overlaps with respective portions of the first waveguide core, the second waveguide core, and the third waveguide core. The layer comprises an electro-optic material.

In an embodiment of the invention, a method of forming a structure for a phase shifter is provided. The method comprises forming a first waveguide core, forming a second waveguide core laterally adjacent to the first waveguide core, and forming a third waveguide core laterally adjacent to the second waveguide core. The second waveguide core and the first waveguide core are separated by a first slot, and the third waveguide core and the first waveguide core are separated by a second slot. The method further comprises forming a layer that overlaps with respective portions of the first waveguide core, the second waveguide core, and the third waveguide core. The layer comprises an electro-optic material.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 1A is a cross-sectional view taken generally along line 1A-1A in FIG. 1.

FIG. 2 is a top view of the structure at a fabrication stage of the processing method subsequent to FIGS. 1, 1A.

FIG. 2A is a cross-sectional view taken generally along line 2A-2A in FIG. 2.

FIG. 3 is a cross-sectional view of the structure at a fabrication stage of the processing method subsequent to FIGS. 2, 2A.

FIG. 4 is a cross-sectional view of a structure in accordance with embodiments of the invention.

FIG. 5 is a cross-sectional view of a structure in accordance with embodiments of the invention.

FIG. 6 is a cross-sectional view of a structure in accordance with embodiments of the invention.

FIG. 7 is a cross-sectional view of a structure in accordance with embodiments of the invention.

FIGS. 8, 8A, 8B are top views of structures in accordance with embodiments of the invention.

FIG. 9 is a top view of a structure in accordance with embodiments of the invention.

### DETAILED DESCRIPTION

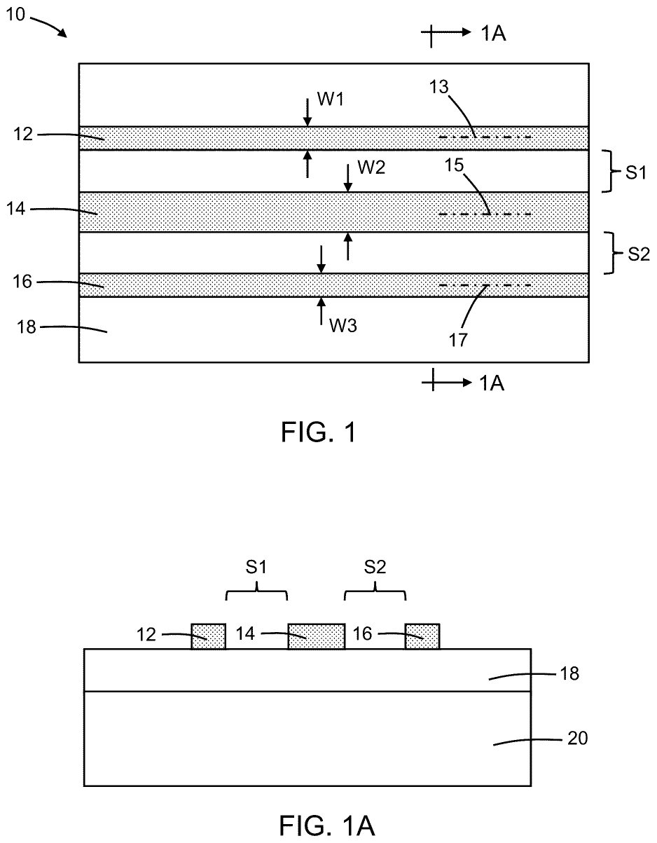

With reference to FIGS. 1, 1A and in accordance with embodiments of the invention, a structure 10 for an electro-optic phase shifter includes a waveguide core 12, a waveguide core 14, and a waveguide core 16 that are positioned on, and above, a dielectric layer 18 and a semiconductor substrate 20. In an embodiment, the dielectric layer 18 may be comprised of a dielectric material, such as an oxide of silicon like silicon dioxide, and the semiconductor substrate 20 may be comprised of a semiconductor material, such as single-crystal silicon. In an embodiment, the dielectric layer 18 may be a buried oxide layer of a silicon-on-insulator substrate. The dielectric layer 18 may provide low-index cladding that separates the waveguide cores 12, 14, 16 from the semiconductor substrate 20.

The waveguide cores 12, 14, 16 may represent a slotted waveguide structure in which the waveguide core 12 is laterally spaced from the waveguide core 14 by a slot S1 and the waveguide core 14 is laterally spaced from the waveguide core 16 by a slot S2. The waveguide core 12 may extend lengthwise along a longitudinal axis 13, the waveguide core 14 may extend lengthwise along a longitudinal axis 15, and the waveguide core 16 may extend lengthwise along a longitudinal axis 17. The waveguide core 12 may have a width dimension W1, the waveguide core 14 may have a width dimension W2, and the waveguide core 16 may have a width dimension W3. The slot S1 and the slot S2 also have respective width dimensions.

In an embodiment, the waveguide cores 12, 14, 16 may be comprised of a material having a refractive index that is greater than the refractive index of silicon dioxide. In an embodiment, the waveguide cores 12, 14, 16 may be comprised of a semiconductor material, such as single-crystal silicon, amorphous silicon, or polysilicon. In an embodiment, the waveguide cores 12, 14, 16 may be comprised of a doped semiconductor material, such as doped single-crystal silicon, doped amorphous silicon, or doped polysilicon. In an alternative embodiment, the waveguide cores 12, 14, 16 may be comprised of a dielectric material, such as silicon nitride, silicon oxynitride, or aluminum nitride. In alternative embodiments, other materials, such as a III-V compound semiconductor, may be used to form the waveguide cores 12, 14, 16.

In an embodiment, the waveguide cores 12, 14, 16 may be formed by patterning a layer comprised of their constituent material with lithography and etching processes. In an embodiment, an etch mask may be formed by a lithography process over the layer, and unmasked sections of the layer may be etched and removed with an etching process. In an embodiment, the waveguide cores 12, 14, 16 may be formed by patterning the semiconductor material (e.g., single-crystal silicon) of the device layer of a silicon-on-insulator substrate. In an embodiment, the waveguide cores 12, 14, 16 may be formed by patterning a deposited layer comprised of its constituent material (e.g., polysilicon or silicon nitride). In an embodiment, a slab layer, which is thinner than the waveguide cores 12, 14, 16, may connect a lower portion of the waveguide core 12 to a lower portion of the waveguide core 14 and a lower portion of the waveguide core 14 to a lower portion of the waveguide core 16.

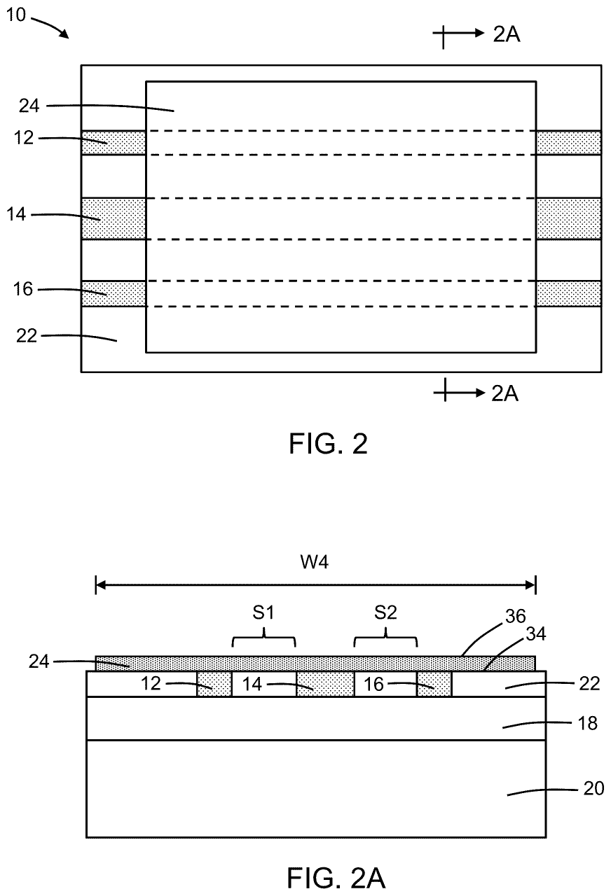

With reference to FIGS. 2, 2A in which like reference numerals refer to like features in FIGS. 1, 1A and at a subsequent fabrication stage, a dielectric layer 22 may be formed over the waveguide cores 12, 14, 16. The dielectric layer 22 may be comprised of a dielectric material, such as an oxide of silicon like silicon dioxide, having a refractive index that is less than the refractive index of the material constituting the waveguide cores 12, 14, 16.

A layer 24 may be formed that overlies the waveguide cores 12, 14, 16. In an embodiment, the layer 24 may be comprised of an electro-optic material that exhibits an electric-field-induced Pockels effect in which the refractive index varies in proportional to the strength of an applied electric field according to a characteristic electro-optic coefficient. In an embodiment, the layer 24 may be comprised of a crystalline material that lacks inversion symmetry and that is characterized by an optic axis having a refractive index is controllable by an applied electric field. In an embodiment, the electro-optic material may be lithium niobate. In alternative embodiments, the electro-optic material may be lithium tantalate, lithium niobate doped with magnesium oxide, or barium titanate. In alternative embodiments, the electro-optic material may be a binary or ternary III-V compound semiconductor material, such as gallium nitride, indium gallium nitride, indium phosphide, indium gallium arsenide, gallium arsenide, indium arsenide, or indium gallium phosphide. In alternative embodiments, the electro-optic material may be an electro-optic polymer.

The layer 24 may fully overlap with an underlying portion of each of the waveguide cores 12, 14, 16. The layer may have a width dimension W4 that is greater than a sum of the width dimension W1 of the waveguide core 12, the width dimension W2 of the waveguide core 14, the width dimension W3 of the waveguide core 16, the width dimension of the slot S1, and the width dimension of the slot S2. The electro-optic material of the layer 24 is absent from the slots S1, S2 and the side surfaces of the waveguide cores 12, 14, 16. Instead, the dielectric material of the dielectric layer 22 may fully fill the slots S1, S2 and may also contact the side surfaces of the waveguide cores 12, 14, 16.

The layer 24 may have a lower surface 34 that is adjacent to the waveguide cores 12, 14, 16 and an upper surface 36 that is opposite from the lower surface 34. In an embodiment, the lower surface 34 and the upper surface 36 of the layer 24 may be planar such that the layer 24 is a planar sheet or thin film. The layer 24 may have a uniform thickness between the lower surface 34 and the upper surface 36. In an embodiment, the layer 24 may directly contact the underlying portions of the waveguide cores 12, 14, 16. The formation of the dielectric layer 22 before forming the layer 24 promotes the planarity by eliminating topography. In an alternative embodiment, a portion of the dielectric layer 22 may be positioned between the layer 24 and the underlying portions of the waveguide cores 12, 14, 16 such that the layer 24 is separated from the underlying portions of the waveguide cores 12, 14, 16 by dielectric material.

In an embodiment, the layer 24 may be deposited and patterned to shape with lithography and etching processes. In an alternative embodiment, the layer 24 may be integrated with the waveguide cores 12, 14, 16 by wafer-to-wafer or die-to-wafer bonding. In an alternative embodiment, a chiplet carrying the layer 24 may be bonded with a chiplet carrying the waveguide cores 12, 14, 16 to provide bonded chiplets.

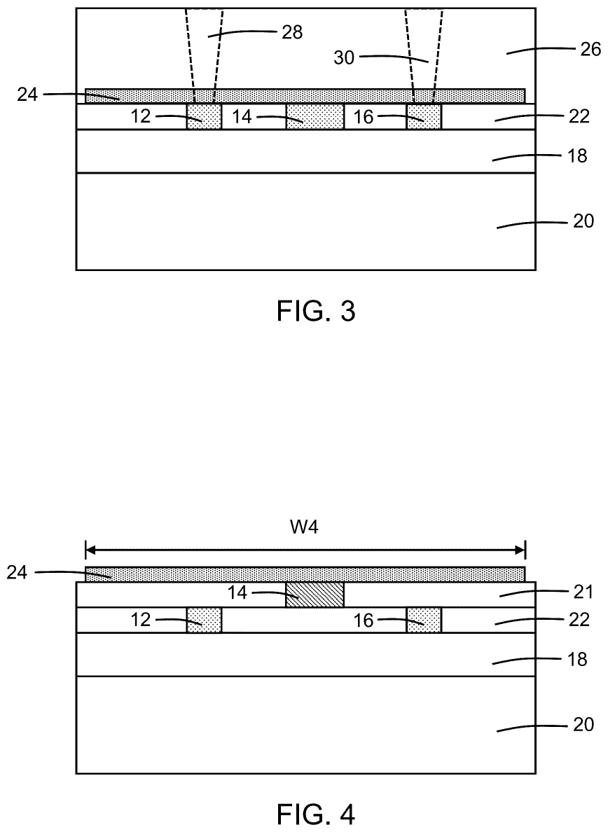

With reference to FIG. 3 in which like reference numerals refer to like features in FIGS. 2, 2A and at a subsequent fabrication stage, a dielectric layer 26 may be formed over the layer 24. The dielectric layer 26 may be comprised of a dielectric material, such as an oxide of silicon (e.g., silicon dioxide), having a refractive index that is less than the refractive index of the material constituting the layer 24.

Contacts 28, 30 may be formed in the dielectric layer 26 that are respectively coupled to the waveguide core 12 and the waveguide core 16 outside of the footprint of the layer 24. The contacts 28, 30 may be comprised of a metal, such as tungsten, copper, or aluminum. In an embodiment in which the waveguide core 12 and the waveguide core 16 are comprised of a conductive material, such as doped silicon, the contacts 28, 30 may be used to apply a modulated electric field to the layer 24 that induces the Pockels effect in the electro-optic material of the layer 24 and causes the refractive index of the material to vary in proportional to the strength of the applied electric field according to the characteristic electro-optic coefficient of the material. The variation in the refractive index of the electro-optic material of the layer 24 may be used to modulate light being guided by the waveguide cores 12, 14, 16. For example, the modulated light may be generated as a binary optical data stream by a modulated electrical signal that is applied through the contacts 28, 30 to vary the refractive index of the electro-optic material of the layer 24.

The structure 10 includes the layer 24 of electro-optic material and a slotted waveguide structure having multiple slots S1, S2 between the waveguide cores 12, 14, 16. The slots S1, S2 may be fully filled by dielectric material. The slotted waveguide structure expands the optical mode of propagating light to interact with the electro-optic material of the layer 24, and the waveguide core 12 and the waveguide core 16 may concurrently act as doped electrodes for applying the electric field to the electro-optic material of the layer 24. The layer 24 does not require precise patterning to be integrated into the slotted waveguide structure. The optical field and electrical field within the layer 24 may exhibit good overlap.

With reference to FIG. 4 and in accordance with alternative embodiments, the waveguide core 14 may be positioned in a different plane than the waveguide core 12 and the waveguide core 16 such that the waveguide core 14 overlies the waveguide core 12 and the waveguide core 16. For example, the waveguide core 14 may be positioned on the dielectric layer 22, and the waveguide core 12 and the waveguide core 16 may be positioned on the dielectric layer 18.

In an embodiment, the waveguide core 14 may be comprised of a different material than the waveguide core 12 and the waveguide core 16. In an embodiment, the waveguide core 14 may be comprised of silicon nitride, and the waveguide core 12 and the waveguide core 16 may be comprised of silicon.

A dielectric layer 21 may be formed over the waveguide core 14 after the waveguide core 14 is formed, and the layer 24 may be formed on the dielectric layer 21. The layer 24 may have a contacting relationship with the waveguide core 14 but not with the waveguide core 12 and the waveguide core 16. An electric field may be applied to the layer 24 to provide variation of the refractive index of its electro-optic material by capacitive coupling with the waveguide core 12 and the waveguide core 16.

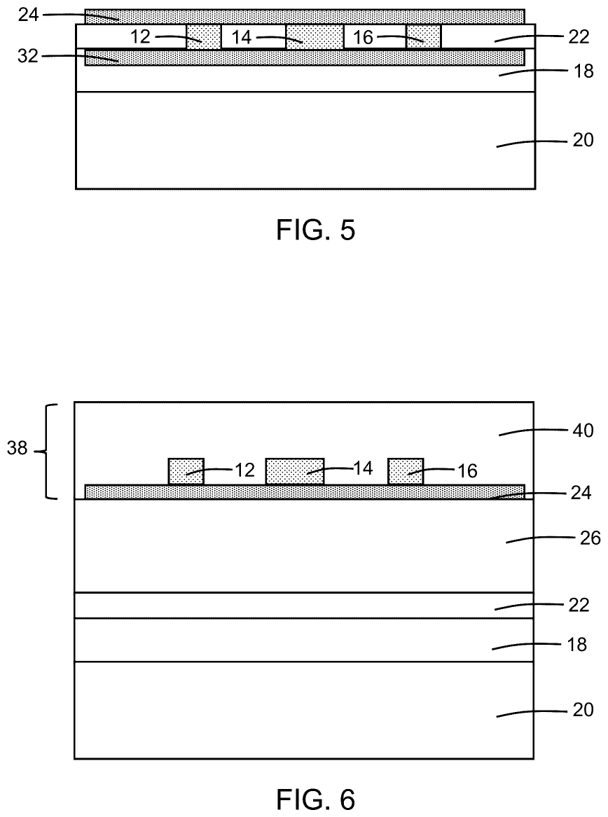

With reference to FIG. 5 and in accordance with alternative embodiments, another layer 32 also comprised of an electro-optic material may be formed in addition to the layer 24. In an embodiment, the layer 32 may be comprised of the same electro-optic material as the layer 24. In an embodiment, the layer 32 may be added by wafer-to-wafer or die-to-wafer bonding. The waveguide cores 12, 14, 16 are positioned in a vertical direction between the layer 24 and the layer 32, and both layers 24, 32 fully overlap with portions of the waveguide cores 12, 14, 16.

With reference to FIG. 6 and in accordance with alternative embodiments, the waveguide cores 12, 14, 16 and the layer 24 may be included in the dielectric layers 39 of a back-end-of-line stack 38. The dielectric layers 39 of the back-end-of-line stack 38 may be comprised of dielectric materials, such as silicon dioxide, silicon nitride, tetraethylorthosilicate silicon dioxide, and/or fluorinated-tetraethylorthosilicate silicon dioxide, and metal features, such as interconnects and vias comprised of copper and aluminum, may be disposed within the dielectric layers 39 and coupled to the waveguide core 12 and the waveguide core 16.

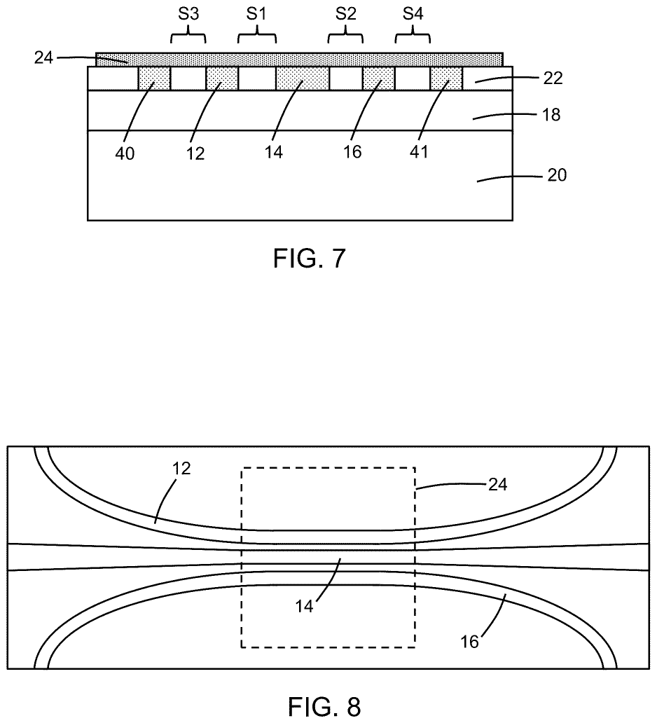

With reference to FIG. 7 and in accordance with alternative embodiments, the structure 10 may include a waveguide core 40 and a waveguide core 41 in addition to the waveguide cores 12, 14, 16. In an embodiment, the waveguide core 40, 41 may be comprised of the same material as the waveguide cores 12, 14, 16. The waveguide core 40 may be laterally separated from the waveguide core 12 by a slot S3 and the waveguide core 41 may be laterally separated from the waveguide core 16 by a slot S4. The electro-optic material of the layer 24 may fully overlap with an underlying portion of each of the waveguide cores 12, 14, 16 and each of the waveguide cores 40, 41. In an embodiment, the electro-optic material of the layer 24 may directly contact an underlying portion of each of the waveguide cores 12, 14, 16 and each of the waveguide cores 40, 41.

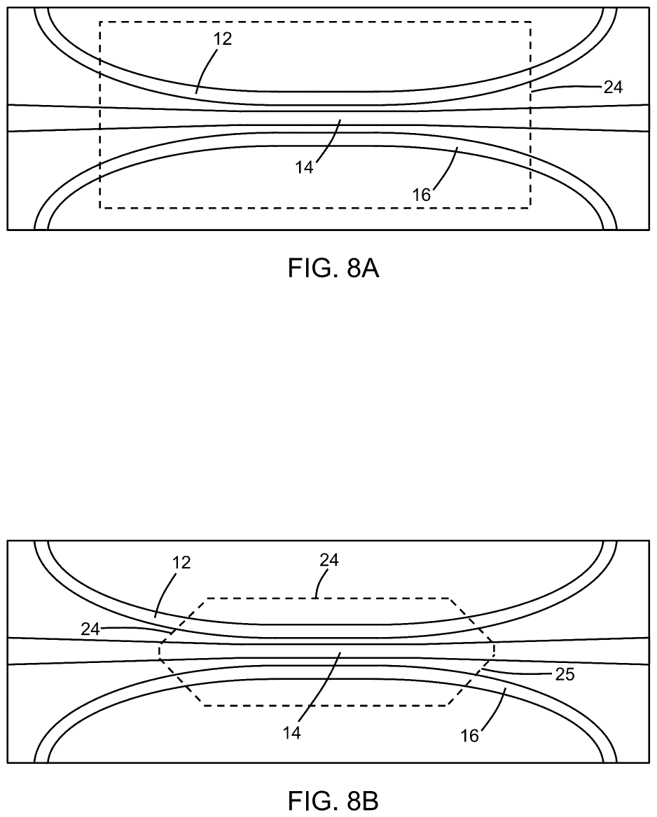

With reference to FIGS. 8, 8A, 8B and in accordance with alternative embodiments, the waveguide cores 12, 14, 16 may have an arrangement in which the waveguide core 12 and the waveguide core 16 terminate at opposite curved ends such that each gradually approaches the waveguide core 14 and each gradually recedes away from the waveguide core 14. The waveguide core 12 includes a portion between the opposite curved ends that is disposed adjacent to the portion of the waveguide core 14. The waveguide core 16 includes a portion between the opposite curved ends that is disposed adjacent to the portion of the waveguide core 14. The portion of the waveguide core 14 between the portion of the waveguide core 12 and the portion of the waveguide core 16 may be connected to tapered portions.

The dielectric layer 22 and the layer 24 are subsequently formed over the waveguide cores 12, 14, 16. In an embodiment, the layer 24 may be arranged over the adjacent portions of the waveguide cores 12, 14, 16. In an alternative embodiment and as shown in FIG. 8A, the layer 24 may be extended to also overlie the tapered portions of the waveguide core 14 and the curved portions of the waveguide core 12 and the waveguide core 16. In an alternative embodiment and as shown in FIG. 8B, the layer 24 may have opposite tapered ends that extend laterally over the tapered portions of the waveguide core 14 and the curved portions of the waveguide core 12 and the waveguide core 16. The tapered ends of the layer 24 include chamfered surfaces 25 that may function to reduce optical return loss.

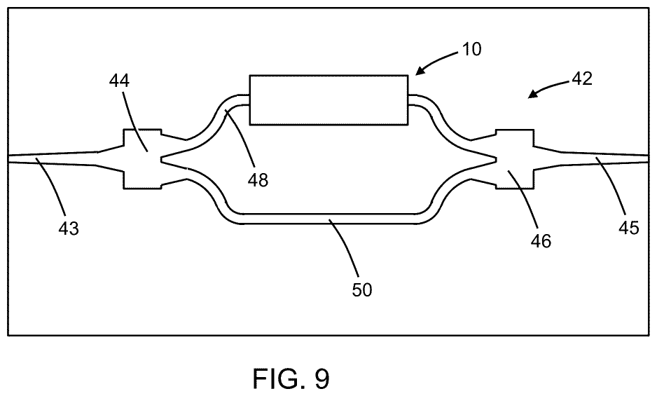

With reference to FIG. 9 and in accordance with alternative embodiments, a Mach-Zehnder interferometer 42 includes an input optical coupler 44, an output optical coupler 46, and waveguide cores 48, 50 defining arms that are separately routed from the input optical coupler 44 to the output optical coupler 46. An input waveguide core 43 is coupled to the input optical coupler 44, and an output waveguide core 45 coupled to the output optical coupler 46. One of the arms of the Mach-Zehnder interferometer 42 may integrate an electro-optic phase shifter embodied in the structure 10. The electro-optic phase shifter may be used to generate a phase difference between the light propagating in the different waveguide cores 48, 50 of the Mach-Zehnder interferometer 42 for generating a modulated light signal at the output port from the output optical coupler 46. The modulation may be achieved by applying an electrical signal to the electro-optic material of the layer 24 embedded in the electro-optic phase shifter.

In an alternative embodiment, the structure 10 may be integrated into a micro-ring resonator. In an alternative embodiment, the structure 10 may be integrated into a ring-assisted Mach-Zehnder interferometer.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction or plane in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or “directly contacting” another feature if intervening features are absent. A feature may be “indirectly on” or in “indirect contact” with another feature if at least one intervening feature is present. Different features may “overlap” if a feature extends over, and covers a part of, another feature. A feature may “overlie” another feature if a feature is positioned “over” another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a phase shifter, the structure comprising:
a first waveguide core;
a second waveguide core laterally adjacent to the first waveguide core, the second waveguide core and the first waveguide core separated by a first slot;
a third waveguide core laterally adjacent to the second waveguide core, the third waveguide core and the second waveguide core separated by a second slot; and
a first layer that overlaps with respective portions of the first waveguide core, the second waveguide core, and the third waveguide core, the first layer comprising a first electro-optic material.

2. The structure of claim 1 wherein the first electro-optic material is lithium niobate, lithium tantalate, lithium niobate doped with magnesium oxide, or barium titanate.

3. The structure of claim 1 wherein the first electro-optic material is a III-V compound semiconductor.

4. The structure of claim 1 wherein the second waveguide core is laterally positioned between the first waveguide core and the third waveguide core.

5. The structure of claim 4 wherein the first waveguide core and the third waveguide core comprise a first material, and the second waveguide core comprises a second material different from the first material.

6. The structure of claim 5 wherein the first material is doped silicon, and the second material is silicon nitride.

7. The structure of claim 4 wherein the first layer directly contacts the first waveguide core, the second waveguide core, and the third waveguide core.

8. The structure of claim 4 wherein the first waveguide core and the third waveguide core comprise doped silicon.

9. The structure of claim 4 wherein the second waveguide core overlies the first waveguide core and the third waveguide core, and the first layer directly contacts the second waveguide core.

10. The structure of claim 4 further comprising:
a fourth waveguide core laterally adjacent to the first waveguide core, the fourth waveguide core and the first waveguide core separated by a third slot,
wherein the first layer overlaps with a portion of the fourth waveguide core.

11. The structure of claim 10 further comprising:
a fifth waveguide core laterally adjacent to the third waveguide core, the fifth waveguide core and the third waveguide core separated by a fourth slot,
wherein the first layer overlaps with a portion of the fifth waveguide core.

12. The structure of claim 1 wherein the layer overlaps with the first slot and the second slot.

13. The structure of claim 1 further comprising:
a dielectric layer comprising a dielectric material,
wherein the dielectric material of the dielectric layer fully fills the first slot and the second slot.

14. The structure of claim 13 wherein the layer overlaps with the first slot and the second slot.

15. The structure of claim 14 wherein the first layer has a first surface and a second surface opposite from the first surface, the first surface is adjacent to the first slot and the second slot, the first surface is planar, and the second surface is planar.

16. The structure of claim 1 wherein the first layer has a first surface and a second surface opposite from the first surface, the first surface is adjacent to the first waveguide core, the second waveguide core, and the third waveguide core, the first surface is planar, and the second surface is planar.

17. The structure of claim 1 wherein the first layer has a first end and a second end opposite from the first end, the first end has a first chamfered surface, and the second end has a second chamfered surface.

18. The structure of claim 1 further comprising:
a second layer comprising a second electro-optic material,
wherein the first waveguide core, the second waveguide core, and the third waveguide core are positioned between the first layer and the second layer.

19. The structure of claim 1 further comprising:
a back-end-of-line stack including a plurality of dielectric layers,
wherein the first waveguide core, the second waveguide core, the third waveguide core, and the first layer are positioned within the plurality of dielectric layers.

20. A method of forming a structure for a phase shifter, the method comprising:
forming a first waveguide core;
forming a second waveguide core laterally adjacent to the first waveguide core, wherein the second waveguide core and the first waveguide core are separated by a first slot;
forming a third waveguide core laterally adjacent to the second waveguide core, wherein the third waveguide core and the second waveguide core are separated by a second slot; and
forming a layer that overlaps with respective portions of the first waveguide core, the second waveguide core, and the third waveguide core, wherein the layer comprises an electro-optic material.
